(19) United States
(12) Patent Application Publication
(10) Pub. No.: US 2019/0394065 A1
(43) Pub. Date: Dec. 26, 2019

(54) INFORMATION MANAGEMENT SYSTEM, IN-VEHICLE DEVICE, SERVER, AND ROUTING TABLE CHANGE METHOD

(71) Applicant: DENSO CORPORATION, Kariya-city (JP)

(72) Inventors: Kohei Okubo, Kariya-city (JP); Kazuaki Hayakawa, Kariya-city (JP); Takuya Hasegawa, Kariya-city (JP)

(21) Appl. No.: 16/561,464

(22) Filed: Sep. 5, 2019

Related U.S. Application Data
(63) Continuation of application No. PCT/JP2018/010001, filed on Mar. 14, 2018.

(30) Foreign Application Priority Data
Mar. 14, 2017 (JP) 2017-048359

(51) Int. Cl. H04L 12/40; H04L 12/24; H04L 12/759

(52) U.S. Cl. CPC H04L 12/40032; H04L 41/0803; H04L 2012/40273; H04L 45/028; H04L 41/12

(57) ABSTRACT

An information management system is provided. The information management system includes an in-vehicle device mounted on a vehicle and a server configured to communicate with the in-vehicle device. The in-vehicle device may relay communication between a plurality of functional units based on a routing table. The in-vehicle device may acquire at least one discrete identification information item. The in-vehicle device may transmit the at least one discrete identification information item. The server may acquire a discrete attribute information item of at least one of the plurality of functional units. The information management system may determine a change in the routing table based on a plurality of discrete attribute information items, and execute the change in the routing table.

### CROSS REFERENCE TO RELATED APPLICATIONS

The present application is a continuation application of International Patent Application No. PCT/JP2018/010001 filed on Mar. 14, 2018, which designated the U.S. and claims the benefit of priority from Japanese Patent Application No. 2017-048359 filed on Mar. 14, 2017. The entire disclosures of all of the above applications are incorporated herein by reference.

### TECHNICAL FIELD

The present disclosure relates to an information management system, an in-vehicle device, a server, and a routing table change method each of which manages an instrument mounted on a vehicle.

### BACKGROUND

A vehicle that causes various electronic control units to operate in cooperation by connecting the electronic control units to a vehicle interior network has been proposed.

### SUMMARY

The present disclosure provides an information management system including an in-vehicle device mounted on a vehicle and a server configured to communicate with the in-vehicle device. The in-vehicle device may relay communication between a plurality of functional units based on a routing table.

### BRIEF DESCRIPTION OF DRAWINGS

The features and advantages of the present disclosure will become more apparent from the following detailed description made with reference to the accompanying drawings. In the drawings:

FIG. 1 is a block diagram illustrating a configuration of an information management system according to a first embodiment;

FIG. 2 is a function block diagram illustrating the information management system according to first embodiment;

FIG. 3 is a sequence diagram illustrating an entire process of the information management system according to the first embodiment;

FIG. 4 is a flowchart illustrating a service management process according to the first embodiment;

FIG. 5 is a flowchart illustrating a service addition process according to the first embodiment;

FIG. 6 illustrates a service usage situation;

FIG. 7 is a flowchart illustrating a service removal process according to the first embodiment;

FIG. 8 is a function block of a server according to a second embodiment;

FIG. 9 is a sequence diagram illustrating an entire process of the information management system according to the second embodiment;

FIG. 10A is a block diagram illustrating a configuration of a server according to a third embodiment;

FIG. 10B is a function block of the server according to the third embodiment;

FIG. 11 is a sequence diagram illustrating an entire process of the information management system according to the third embodiment;

FIG. 12A is a block diagram illustrating a configuration of a communication manager according to a fourth embodiment;

FIG. 12B is a function block of the communication manager according to the fourth embodiment; and

FIG. 13 is a sequence diagram illustrating an entire process of the information management system according to the fourth embodiment.

### DETAILED DESCRIPTION

For example, use of the same platform to operate applications has been proposed. In this configuration, reliable reuse of an application to construct a new system or interoperation of a plurality of applications can be ensured.

A vehicle may include a plurality of cooperative electronic control units installed with functional units to provide a heterogeneous function. The inventors examine improvement of the interoperability among a plurality of functional units by managing the electronic control unit. The inventors found that various issues occur due to an excessive increase in the size of data needed for communication targeted at the interoperation with other functional units when an electronic control unit or a functional unit is newly added to a network.

The present disclosure provides an information management system, an in-vehicle device, a server, and a routing table change method to restrain an increase in communication loads when a new function is added or changed.

An example embodiment of the present disclosure provides an information management system including an in-vehicle device mounted on a vehicle and a server configured to communicate with the in-vehicle device.

The in-vehicle device includes a communication relayer, an information acquirer, and a transmitter. The communication relayer, based on a routing table, relays communication between a plurality of functional units each of which provides a predetermined function. The information acquirer acquires at least one discrete identification information item out of a plurality of discrete identification information items each of which corresponds to one of the plurality of functional units. The transmitter transmits the at least one discrete identification information item acquired by the information acquirer to the server.

The server includes an attribute acquirer. The attribute acquirer acquires a discrete attribute information item of at least one of the plurality of functional units corresponding to the at least one discrete identification information item transmitted from the transmitter.

The information management system further includes a finalizer and a changer. The finalizer determines a change in the routing table based on a plurality of discrete attribute information items each of which corresponds to one of the plurality of functional units. The plurality of discrete attribute information items includes the discrete attribute information item of the at least one of the plurality of functional units acquired by the attribute acquirer. The changer executes the change in the routing table based on the change determined by the finalizer.

In the example embodiment of the present disclosure, the server acquires the attribute information related to a functional unit based on the identification information of the functional unit that is added or changed. The functional unit need not notify the attribute to the server. Thus, the configuration enables to restrain an increase in communication loads on a network when a new function is added or changed.

An example embodiment of the present disclosure provides an in-vehicle device mounted on a vehicle and configured to communicate with a server outside the vehicle. The in-vehicle device includes a communication relayer, an information acquirer, and a transmitter. The communication relayer, based on a routing table, relays communication between a plurality of functional units each of which provides a predetermined function. The information acquirer acquires at least one discrete identification information item out of a plurality of discrete identification information items each of which corresponds to one of the plurality of functional units. The transmitter transmits the at least one discrete identification information item acquired by the information acquirer to the server.

In the example embodiment of the present disclosure, the in-vehicle device can configure part of the information management system according to the first aspect of the above-described present disclosure.

An example embodiment of the present disclosure provides a server configured to communicate with an in-vehicle device mounted on a vehicle. The server includes an attribute acquirer. The attribute acquirer acquires a discrete attribute information item of at least one functional unit, which is attached to the vehicle and provides a predetermined function, based on a discrete identification information item that corresponds to the at least one functional unit.

In the example embodiment of the present disclosure, the server can configure part of the information management system according to the first aspect of the above-described present disclosure.

An example embodiment of the present disclosure provides a routing table change method. The routing table change method is used when a communication relayer included in a client configured to communicate with a server relays communication between a plurality of functional units each of which provides a predetermined functions.

The routing table change method includes (i) acquiring, by the client, at least one discrete identification information item that corresponds to at least one functional unit out of the plurality of functional units, (ii) acquiring, by the server, a discrete attribute information item of the at least one functional unit based on the at least one discrete identification information item, the at least one functional unit being specified by the at least one discrete identification information item, (iii) determining a change in a routing table based on a plurality of discrete attribute information items each of which corresponds to one of the plurality of functional units, the plurality of discrete attribute information items including the discrete attribute information item of the at least one functional unit, and (iv) executing the change in the routing table based on the determined change.

In the example embodiment of the present disclosure, the functional unit in the client need not notify the attribute information to the server. Thus, the configuration can restrain an increase in communication loads when a new function is added or changed in a client network.

Embodiments of the present disclosure will be described with reference to the accompanying drawings.

[1. First Embodiment]

[1-1. Entire Configuration]

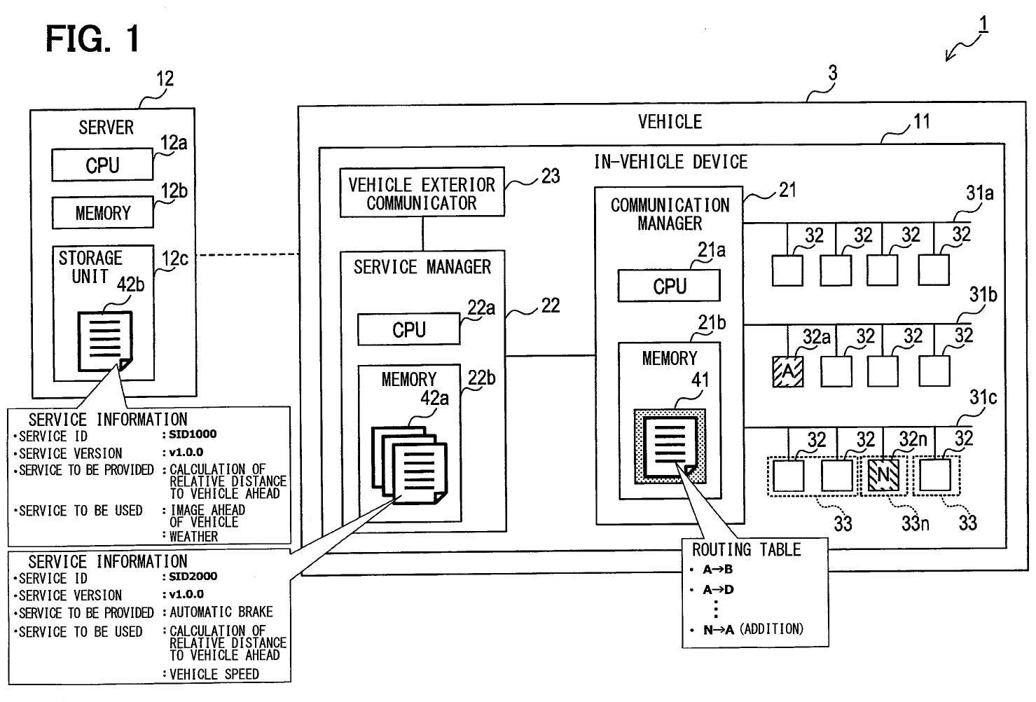

An information management system 1 illustrated in FIG. 1 includes an in-vehicle device 11 and a server 12. The in-vehicle device 11 is mounted on a vehicle. The server 12 is capable of communicating with the in-vehicle device 11. The in-vehicle device 11 is a client communicating with the server 12.

The in-vehicle device 11 includes a communication manager 21, a service manager 22, and a vehicle exterior communicator 23.

The communication manager 21 is equipped with a well-known microcontroller including a CPU 21a and a semiconductor memory (hereinafter referred to as a memory 21b) such as RAM, ROM, or flash memory. The communication manager 21 provides various functions by allowing the CPU 21a to execute a program stored in a non-transitory tangible storage medium. In this example, the memory 21b is comparable to the non-transitory tangible storage medium that stores the program. The program is executed to perform a method corresponding to the program. The memory 21b stores a routing table 41.

The communication manager 21 connects with a plurality of vehicle interior networks 31a through 31c. Each of the networks connects with a plurality of functional units 32. The functional unit 32 here signifies an element that embodies a specified function. The functional units 32 each are configured to be capable of embodying a certain function. The explanation below also describes a service as a result acquired from the function of the functional unit 32.

Specifically, the functional unit 32 is embodied by an information processor including a CPU such as an Electronic Control Unit (hereinafter referred to as an ECU 33). One information processor does not necessarily embody one functional unit 32. One information processor may embody a plurality of functional units 32 or a plurality of the information processors may embody one functional unit 32. In FIG. 1, an ECU 33n embodies a functional unit 32n as one of the functional units 32.

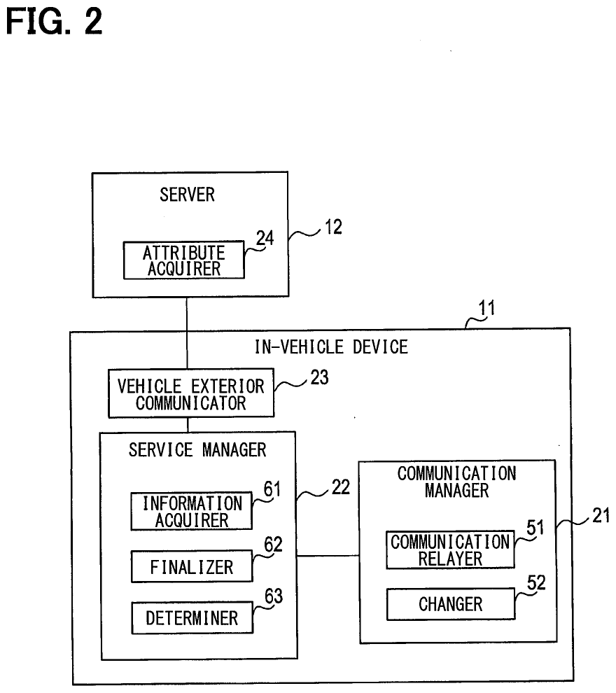

As illustrated in FIG. 2, the communication manager 21 includes a communication relayer 51 and a changer 52 as a configuration of functions by allowing the CPU 21a to execute a program. Specific functions of the communication relayer 51 and the changer 52 will be described later.

The service manager 22 is equipped with a well-known microcontroller including a CPU 22a and a semiconductor memory (hereinafter referred to as a memory 22b) such as RAM, ROM, or flash memory. The service manager 22 provides various functions by allowing the CPU 22a to execute a program stored in a non-transitory tangible storage medium. In this example, the memory 22b is comparable to the non-transitory tangible storage medium that stores the program. The program is executed to perform a method corresponding to the program. The memory 22b stores service information 42a related to each of the functional units 32 mounted on the in-vehicle device 11.

One piece of service information 42a includes a “service to be provided” by the functional unit 32 and a “service to be used” by the functional unit 32. The service to be provided by the functional unit 32 signifies the contents of information that can be output by allowing the functional unit 32 related to the service information 42a to execute a function. The service to be used by the functional unit 32 signifies the contents of information output from another functional unit 32 needed for the relevant functional unit 32 to execute functions.

For example, the service information 42a related to the functional unit 32a connected to the vehicle interior network 31b in FIG. 1 includes “automatic braking” as a service to be provided, “calculation of relative distance to the vehicle ahead” and “vehicle speed” as services to be used.

The service information 42a and service information 42b (to be described) that includes the same type of information are comparable to attributes of the functional units. The service information 42a or 42b, if not distinguished, is also described as service information 42.

As illustrated in FIG. 2, the service manager 22 includes an information acquirer 61, a finalizer 62, and a determiner 63 as a configuration of functions by allowing the CPU 22a to execute a program.

The communication manager 21 and the service manager 22 may include one or more microcontrollers. A technique to embody the elements configuring the communication manager 21 and the service manager 22 is not limited to the software. One or more hardware components may be used to embody all or part of the elements. When an electronic circuit as hardware implements the above-described functions, the electronic circuit may be provided as a digital circuit, an analog circuit, or a combination of these, whichever includes many logic circuits.

The server 12 is installed outside a vehicle mounted with the in-vehicle device 11. The server 12 is mainly configured as a well-known computer system including a CPU 12a, a semiconductor memory (hereinafter referred to as a memory 12b) such as RAM, ROM, or flash memory, a storage unit 12c such as a hard disk having a large storage area, and an unshown communication device. The server 12 provides various functions by allowing the CPU 12a to execute a program stored in a non-transitory tangible storage medium. In this example, the memory 12b is comparable to the non-transitory tangible storage medium that stores the program. The program is executed to perform a method corresponding to the program. The storage unit 12c stores the service information 42b corresponding to each one or more functional units. The storage unit 12c to store the service information 42b may be placed dispersedly at a plurality of locations inside and outside the server 12.

For example, the server 12 includes the service information 42b related to the functional unit 32n connected to the vehicle interior network 31c in FIG. 1. The service information 42b includes “calculation of relative distance to the vehicle ahead” as a service to be provided and “image ahead of the vehicle” and “‘weather” as services to be used.

As illustrated in FIG. 2, the server 12 includes an attribute acquirer 24 as a configuration of a function by allowing the CPU 12a to execute a program.

[1-2. Function of Each Component]

The communication relayer 51 relays communication among a plurality of functional units 32 based on the routing table 41. Namely, the communication relayer 51 causes the communication manager 21 to function as a gateway. The vehicle interior networks connected to the communication manager 21 do not necessarily use different protocols but all or part of the networks may use the same protocol.

The routing table 41 includes information related to routing to the functional unit 32 as a destination communicating with each functional unit 32 mounted on the vehicle. The routing table is not limited to any forms, styles, or data structures on condition that the CPU 21a can provide the above-described relay by referencing or using the routing table.

The information acquirer 61 acquires at least one of a plurality of service IDs corresponding to a plurality of functional units 32 mounted on the in-vehicle device 11. The service ID is comparable to a discrete identification information item. The service ID is transmitted from the ECU 33 that embodies the functional unit 32. The ECU 33 periodically (such as every 30 seconds) outputs a service ID notification, namely a service ID of the functional unit 32 the relevant ECU 33 can embody.

The determiner 63 determines whether the functional unit 32 is added or removed based on the service ID transmitted from the ECU 33. If the functional unit 32 is added or removed, the service ID transmitted from the ECU 33 increases or decreases or no service ID is transmitted. The determiner 63 identifies addition or removal of the functional unit 32 based on the transmitted service ID.

The vehicle exterior communicator 23 is a communication device capable of wireless communication and communicates with the server 12 via the Internet or the like. The vehicle exterior communicator 23 is not limited to a specific configuration simply on condition that communication with the server 12 is available. The vehicle exterior communicator 23 transmits at least one service ID acquired by the information acquirer 61 to the server 12. The vehicle exterior communicator 23 is comparable to a transmitter. When the determiner 63 determines that the functional unit 32 is added, the vehicle exterior communicator 23 transmits the service ID of the added functional unit 32 to the server 12 according to the present embodiment.

Out of a plurality of pieces of the service information 42b stored in the storage unit 12c, the attribute acquirer 24 acquires at least one piece of service information 42b corresponding to at least one service ID transmitted by the vehicle exterior communicator 23.

The finalizer 62 determines a change in the routing table 41 based on a plurality of pieces of the service information 42 corresponding to a plurality of the functional units 32. A plurality of pieces of the service information 42 include the service information 42b that is acquired by the attribute acquirer 24 and concerns at least one functional unit 32 notified from the server 12 later on. The changer 52 executes the change in the routing table 41 based on the change determined by the finalizer 62.

The description below explains an example of newly adding the above-described functional unit 32n.

In the in-vehicle device 11, when the determiner 63 determines that the service ID acquired by the information acquirer 61 concerns the added functional unit 32n, the vehicle exterior communicator 23 transmits the service ID concerning the functional unit 32n to the server 12.

In the server 12, when the attribute acquirer 24 acquires the service ID of the functional unit 32n, the service information 42b corresponding to the functional unit 32n is acquired and is transmitted to the in-vehicle device 11.

The functional unit 32n includes “calculation of relative distance to the vehicle ahead” as “service to be provided” and “calculation of relative distance to the vehicle ahead” is included in “service to be used” for the functional unit 32a. Supposing that the function of “calculation of relative distance to the vehicle ahead” is a new “service to be provided” in the in-vehicle device 11, the functional unit 32n is requested to output information on “calculation of relative distance to the vehicle ahead” to the functional unit 32a. The finalizer 62 determines a change in the routing table 41 to add a route from the functional unit 32n to the functional unit 32a.

Supposing that the functional unit 32n provides “calculation of relative distance to the vehicle ahead” that is not new, the configuration is to (i) avoid changing the routing table 41; or (ii) determine whether there is a change according to priorities compared with “calculation of relative distance to the vehicle ahead” provided from another functional unit. For example, the “calculation of relative distance to the vehicle ahead” service provided by the functional unit 32n may be more accurate than the same service provided from another functional unit 32 or may be compatible with the service from the functional unit 32a. In such a case, the route may be changed so as to transmit the information from the functional unit 32n to the functional unit 32a.

[1-3. Processes]

<Process of the Entire System>

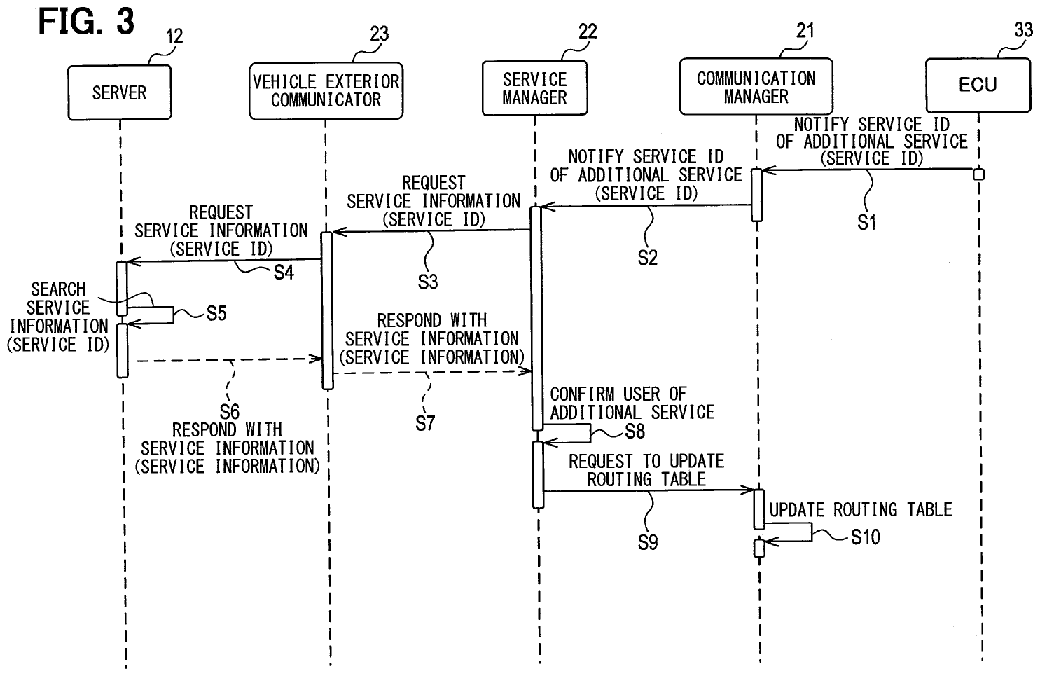

A sequence diagram in FIG. 3 is used to explain a process performed by the information management system 1. This process starts when each ECU 33 periodically executes S1.

In S1, the ECU 33 outputs a service ID notification to the communication manager 21. The ECU 33 notifies the communication manager 21 of a service ID for the functional unit 32 included in the ECU 33.

In S2, the communication manager 21 outputs the service ID notification acquired in S1 to the service manager 22.

In S3, when the service ID notified in S2 is equal to the added service ID for the functional unit 32, the service manager 22 outputs a service information request including the service ID to the vehicle exterior communicator 23.

In S4, the vehicle exterior communicator 23 issues the service information request to the server 12.

In S5, the server 12 searches the storage unit 12c for the service information 42b corresponding to the service ID included in the service information request.

In S6, the server 12 issues a service information response to the vehicle exterior communicator 23. The service information response includes the service information 42b found during the search.

In S7, the vehicle exterior communicator 23 outputs the service information response transmitted from the server 12 to the service manager 22.

In S8, the service manager 22 confirms a user of additional service and determines the change in the routing table 41 resulting from addition of the functional unit 32.

In S9, the service manager 22 outputs a routing table update request to the communication manager 21.

In S10, the communication manager 21 updates the routing table 41 based on the routing table update request acquired from the service manager 22. The process in S10 corresponds to the process performed by the changer 52.

<Service Management Process Performed by the Service Manager>

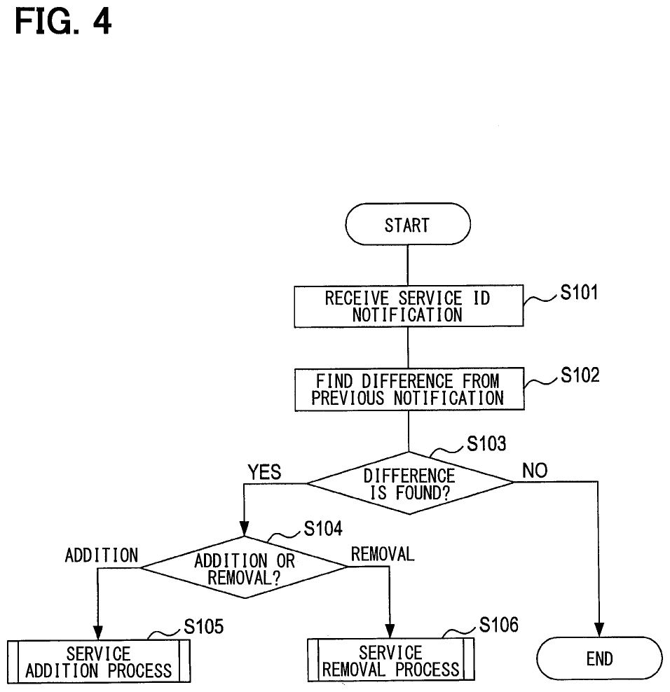

A flowchart in FIG. 4 is used to explain the service management process performed by the CPU 22a of the service manager 22.

In S101, the CPU 22a receives a service ID notification from the ECU 33. This service ID notification corresponds to a functional unit the ECU 33 can provide. S101 provides the process performed by the information acquirer 61.

In S102, the CPU 22a compares a difference from the previous notification.

In S103, the CPU 22a determines whether there is a difference based on the result from S102. Namely, the CPU 22a determines whether the service ID contained in the service ID notification increases or decreases.

If determining in S103 that there is no difference, the CPU 22a terminates the service management process in FIG. 4.

If determining in S103 that there is a difference, the CPU 22a proceeds to S104 and determines whether the difference signifies addition. The number of service IDs depends on the number of functional units 32 included in the ECU. The number of service IDs increases if the new functional unit 32 is added. The number of service IDs decreases if the functional unit 32 is removed.

In S103, addition is assumed if a new service ID is increased. Removal, not addition, is assumed if the service ID available in the previous notification is unavailable.

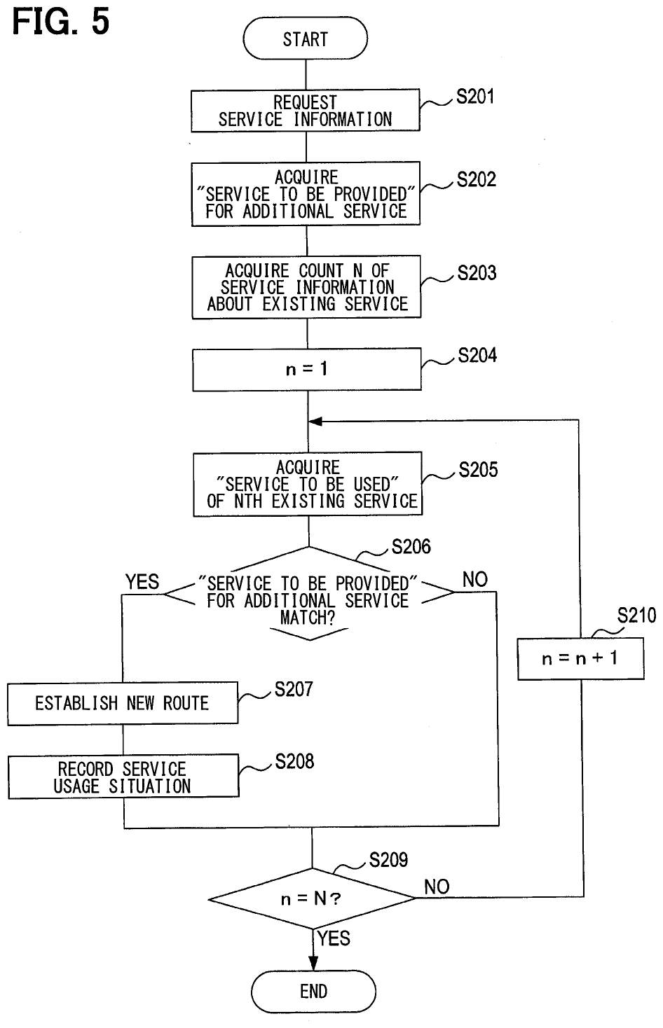

If determining in S104 that the difference signifies addition, the CPU 22a starts the service addition process in FIG. 5.

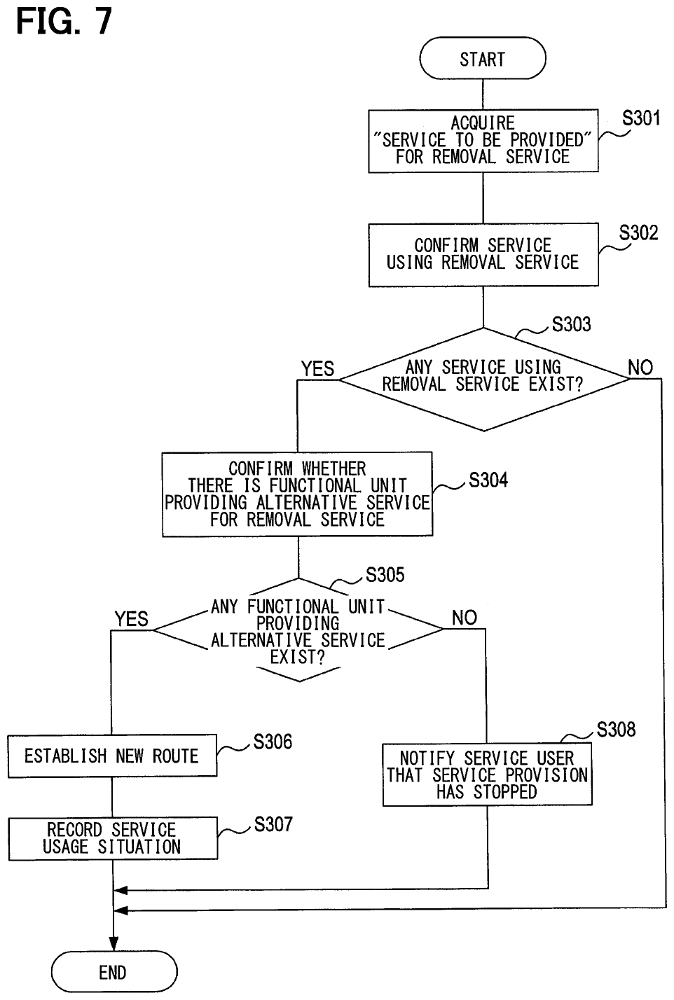

If determining in S104 that the difference signifies removal, not addition, the CPU 22a proceeds to S106 and starts a service removal process in FIG. 7. S102 through S104 correspond to the process performed by the determiner 63.

<Service Addition Process Performed by the Service Manager>

A flowchart in FIG. 5 is used to explain the service addition process performed by the CPU 22a. The explanation below describes “additional service” to represent the functional unit 32 newly added to the vehicle interior networks 31a through 31c and describes “existing service” to represent the functional unit 32 already included in the vehicle interior networks 31a through 31c.

In S201, the CPU 22a issues a service information request to the server 12 and acquires the service information 42b about an additional service from the server 12.

In S202, the CPU 22a acquires “service to be provided” for the service information 42b about the additional service.

In S203, the CPU 22a acquires count N as the number of pieces of the service information 42a related to the existing service. The number of existing services is equal to the number of the functional units 32 the service manager 22 already recognizes. The memory 22b stores the service information 42a corresponding to count N.

In S204, the CPU 22a sets variable n to n=1.

In S205, the CPU 22a acquires “service to be used” for the service information 42a concerning the nth existing service.

In S206, the CPU 22a determines whether there is a match between “service to be provided” acquired in S202 for the additional service and “service to be used” acquired in S205 for the existing service. If determining in S206 that there is no match, the CPU 22a proceeds to S209.

If determining in S206 that there is a match, the CPU 22a proceeds to S207 and establishes a new route. Namely, the CPU 22a outputs a routing table update request to the communication manager 21 so that the information is transmitted from the ECU 33 including the functional unit concerning “service to be provided” to the ECU 33 including the functional unit concerning the “service to be used.” This S207 is equal to the process performed by the finalizer 62.

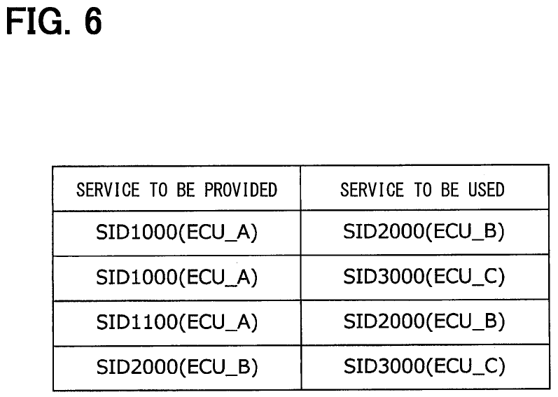

In S208, the CPU 22a records a service usage situation in the memory 22b. The CPU 22a records the relationship between the functional unit 32 to provide the service and the functional unit 32 to receive the service in terms of all the functional units 32 provided for the in-vehicle device 11. FIG. 6 illustrates an example of the service usage situation.

In S209, the CPU 22a determines whether n=N is satisfied. If determining in S209 that n=N is not satisfied, the CPU 22a proceeds to S210, increments n by 1, and returns to S205.

If determining in S209 that n=N is satisfied, the CPU 22a terminates the service addition process in FIG. 5.

<Service Removal Process Performed by the Service Manager>

A flowchart in FIG. 7 is used to explain the service removal process performed by the CPU 22a. The explanation below describes “removal service” to represent the functional unit 32 removed from the vehicle interior networks 31a through 31c.

In S301, the CPU 22a acquires “service to be provided” for the service information 42a related to the removal service.

In S302, the CPU 22a confirms a service using the removal service, namely, a service receiving “service to be provided” acquired in S301.

In S303, the CPU 22a determines whether there is a service using the removal service.

If determining in S303 that there is no service using the removal service, the CPU 22a terminates the service removal process in FIG. 7.

If determining in S303 that there is a service using the removal service, the CPU 22a proceeds to S304. The CPU 22a then determines whether there is the functional unit 32 providing the same service (hereinafter also referred to as an alternative service) as “service to be provided” for the service to be removed from the acquired service information 42a.

In S305, the CPU 22a determines whether there is the functional unit 32 to provide an alternative service.

If determining in S305 that there is the functional unit 32 to provide an alternative service, the CPU 22a proceeds to S306 and establishes a new route between the functional unit 32 to provide an alternative service and a service user. In S307, the CPU 22a records the service usage situation and then terminates the service removal process in FIG. 7. The same processes as those described in S207 and S208 are used to establish the new route and record the service usage situation.

If determining in S305 that there is no functional unit 32 to provide an alternative service, the CPU 22a proceeds to S308 and notifies the functional unit 32 as a service user that the service provision has stopped. The CPU 22a then terminates the service removal process in FIG. 7.

[1-4. Effect]

The above-described first embodiment provides the following effect.

(1a) According to the information management system 1, the server 12 acquires the service information 42 related to the functional unit 32 that is added or changed in the in-vehicle device 11. The functional unit 32 itself does not require output to the communication manager 21, for example. Therefore, it is possible to restrain an increase in communication loads on the vehicle interior networks 31a through 31c.

[2. Second Embodiment]

[2-1. Differences from the First Embodiment]

In terms of the basic configuration, a second embodiment is similar to the first embodiment. Differences will be explained below. The same reference numerals as used for the first embodiment depict the same configuration. The preceding explanation is referenced.

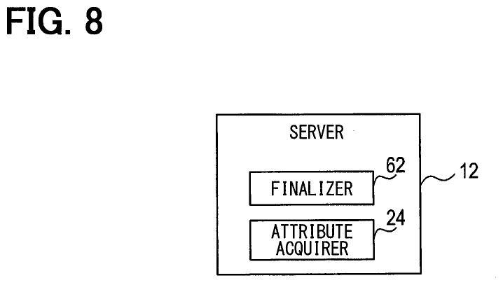

The above-described first embodiment has illustrated the configuration in which the service manager 22 includes the finalizer 62 to perform the processes in FIGS. 5 and 7. The second embodiment differs from the first embodiment in that the server 12 includes the finalizer 62 to perform the processes as illustrated in FIG. 8.

According to the present embodiment, the service manager 22 does not record the service information 42 and the service usage situation. Instead, the server 12 records the service information 42 and the service usage situation so as to correspond to each in-vehicle device 11.

[2-2. Processes]

<Process of the Entire System>

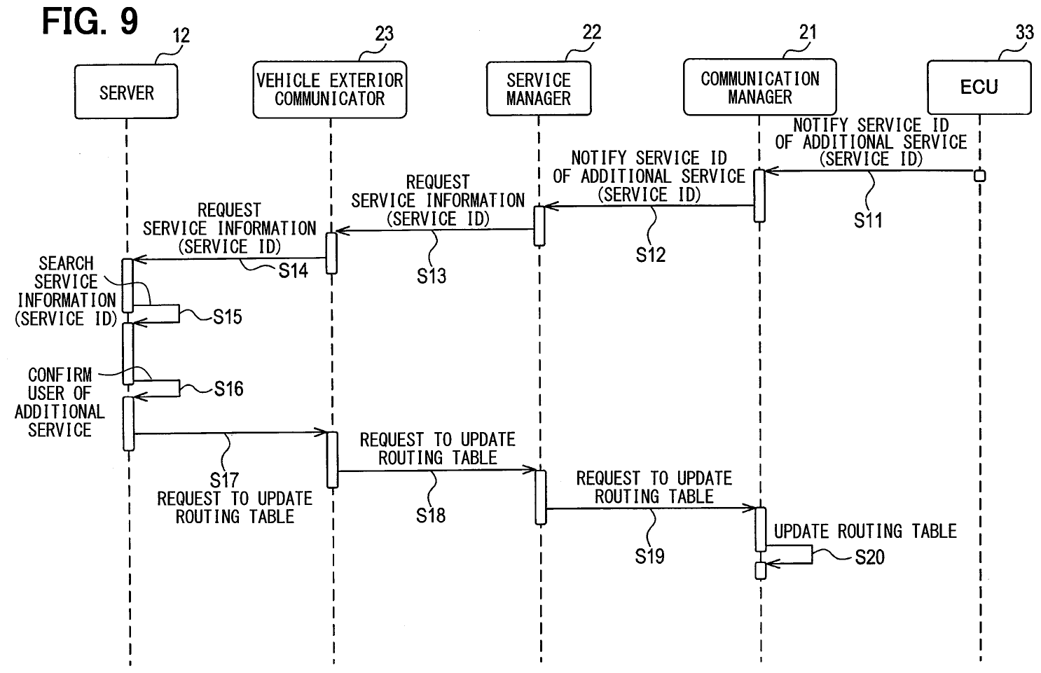

A sequence diagram in FIG. 9 is used to explain a process performed by the information management system 1 according to the second embodiment.

S11 through S15 in FIG. 9 are comparable to S1 through S5 in FIG. 3 and a description is omitted.

In S16, the server 12 confirms a user of the additional service by using the service information 42b found from the search in S15. This determines a change in the routing table 41 resulting from addition of the functional unit 32n.

In S17, the server 12 outputs a routing table update request to the vehicle exterior communicator 23. In S18, the vehicle exterior communicator 23 outputs a routing table update request to the service manager 22. In S19, the service manager 22 outputs a routing table update request to the communication manager 21.

In S20, the communication manager 21 updates the routing table 41 based on the routing table update request acquired from the service manager 22.

[2-3. Effects]

The detailed second embodiment provides the effect (1a) according to the above-described first embodiment and the following effect.

(2a) The server 12 performs the process of finalizing a change in the routing table 41, making it possible to decrease processing loads on the in-vehicle device 11.

[3. Third Embodiment]

[3-1. Differences from the Other Embodiments]

In terms of the basic configuration, the third embodiment is similar to the first and the second embodiments. Differences will be explained below. The same reference numerals as used for the first embodiment depict the same configuration. The preceding explanation is referenced.

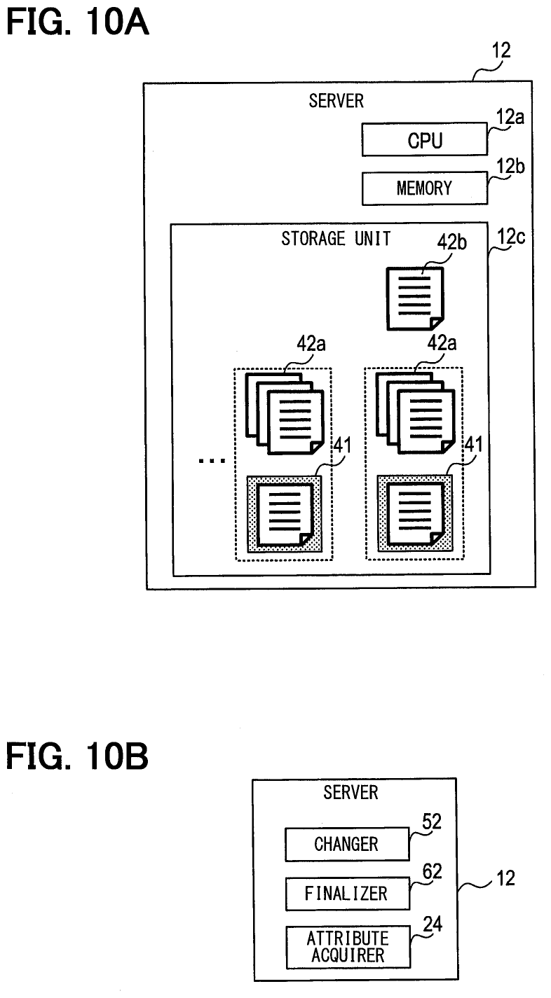

Unlike the first embodiment, the above-described second embodiment has illustrated the configuration in which the server 12 includes the finalizer 62. According to the third embodiment, as illustrated in FIG. 10A, the server 12 stores the routing table 41 for each in-vehicle device 11. As illustrated in FIG. 10B, the server 12 includes the finalizer 62 and the changer 52. The server 12 updates the routing table 41 and outputs the updated routing table 41 to the in-vehicle device 11.

According to the present embodiment, the server 12 records the routing table 41, the service information 42, and the service usage situation so as to correspond to each in-vehicle device 11.

[3-2. Processes]

<Process of the Entire System>

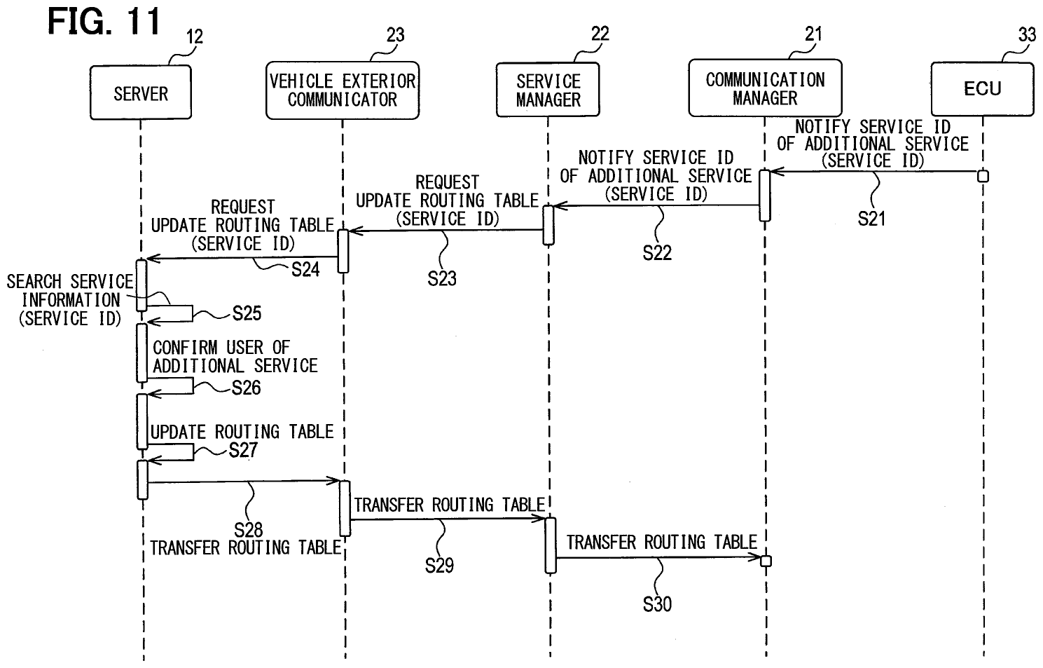

A sequence diagram in FIG. 11 is used to explain a process performed by the information management system 1 according to the third embodiment.

S21 and S22 in FIG. 11 are comparable to S1 and S2 in FIG. 3 and a description is omitted.

In S23, the service manager 22 outputs an update routing table request including the service ID to the vehicle exterior communicator 23.

In S24, the vehicle exterior communicator 23 issues an update routing table request to the server 12.

In S25, the server 12 searches the storage unit 12c for the service information 42b corresponding to the service ID included in the received update routing table request.

In S26, the server 12 confirms a user of the additional service by using the service information 42b found from the search in S25. This determines a change in the routing table 41 resulting from addition of the functional unit 32n.

In S27, the server 12 updates the routing table 41 based on the change in the routing table 41 resulting from addition of the functional unit 32n determined in S26.

In S28, the server 12 outputs the updated routing table 41 to the vehicle exterior communicator 23. In S29, the vehicle exterior communicator 23 outputs the updated routing table 41 to the service manager 22. In S30, the service manager 22 outputs the updated routing table 41 to the communication manager 21.

After S30, the communication manager 21 performs routing by using the routing table 41 acquired in S30.

[3-3. Effects]

The detailed third embodiment provides the effect (1a) according to the above-described first embodiment and the following effect.

(3a) The server 12 performs the processes of finalizing a change in the routing table 41 and updating the routing table 41, making it possible to further decrease processing loads on the in-vehicle device 11.

[4. Fourth Embodiment]

[4-1. Differences from the Other Embodiments]

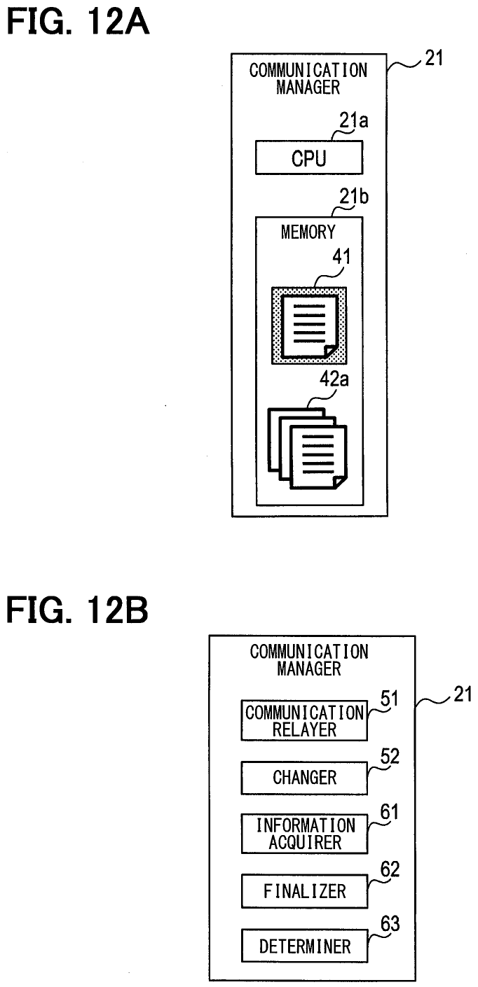

Unlike the first through the third embodiments, the fourth embodiment does not provide the in-vehicle device 11 with the service manager 22. The communication manager 21 performs the function the service manager 22 performs in the first embodiment. As illustrated in FIG. 12A, the memory 21b stores the service information 42 in addition to the routing table 41. As illustrated in FIG. 12B, the communication manager 21 includes the information acquirer 61, the finalizer 62, and the determiner 63. The same reference numerals as used for the first embodiment depict the same configuration. The preceding explanation is referenced.

[4-2. Processes]

<Process of the Entire System>

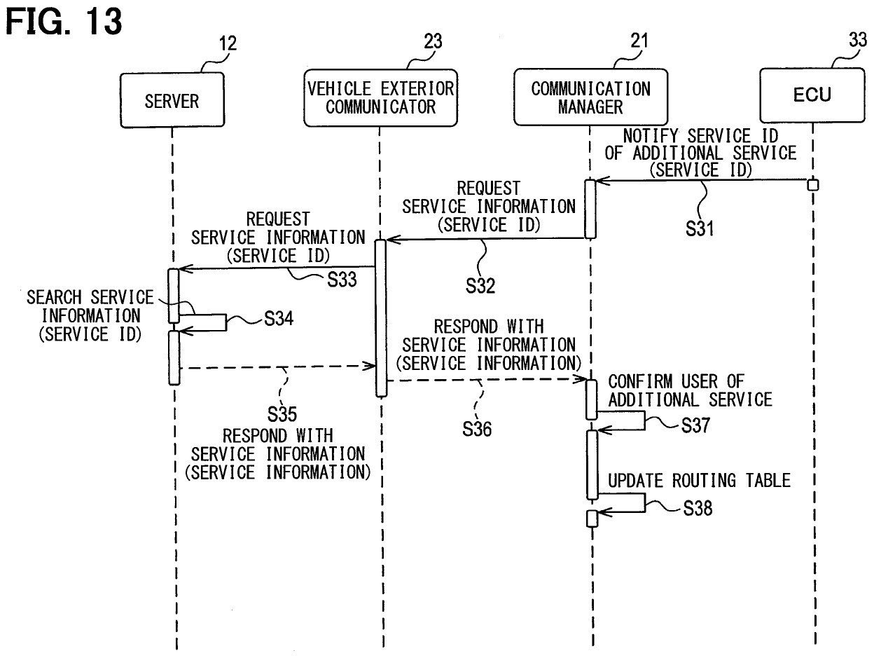

A sequence diagram in FIG. 13 is used to explain a process performed by the information management system 1 according to the fourth embodiment.

In S31, the ECU 33 outputs a service ID notification to the communication manager 21. This process is equal to S1 in FIG. 3.

In S32, the communication manager 21 outputs a service information request including a service ID to the vehicle exterior communicator 23 in order to issue a service information request to the server 12.

In S33, the vehicle exterior communicator 23 issues a service information request to the server 12.

In S34, the server 12 searches the storage unit 12c for the service information 42b corresponding to the service ID included in the received service information request.

In S35, the server 12 issues a service information response to the vehicle exterior communicator 23. The service information response includes the service information 42b found from the search.

In S36, the vehicle exterior communicator 23 outputs the service information response transmitted from the server 12 to the communication manager 21.

In S37, the communication manager 21 confirms a user of the additional service. This process determines a change in the routing table 41 resulting from addition of the functional unit 32.

In S38, the communication manager 21 updates the routing table 41 based on the change determined in S37.

[4-3. Effect]

The detailed fourth embodiment can provide the effect according to the above-described first embodiment.

[5. Other Embodiments]

Although the embodiments of the present disclosure have been described above, the present disclosure is not limited to the embodiments described above, and various modifications can be made to implement the present disclosure.

(5a) The finalizer 62 to determine a change in the routing table 41 and the changer 52 to update the routing table 41 may be provided for any of the server 12 and the in-vehicle device 11 or may be provided for the other devices.

The in-vehicle device 11 may change the routing table 41 based on the change in the routing table 41 while the change is determined based on the service information 42b and the service information 42a. The server 12 acquires the service information 42b about the functional unit 32 based on the service ID. Among a plurality of the functional units 32, the service information 42a concerns the other functional units 32 than the functional unit 32 concerning the above-described service information 42b.

A storage stores the service information 42a about a plurality of the functional units 32 included in the in-vehicle device 11. The server 12 may determine a change in the routing table 41 based on the service information 42b acquired by the attribute acquirer 24 and the service information 42a about the functional units 32 stored in the storage.

(5b) The above-described embodiment has illustrated the configuration that mutually associates a plurality of the functional units 32 connected to the in-vehicle device 11 and determines a change in the routing table 41 based on the relationship between “service to be provided” and “service to be used” as attribute information included in the service information 42. However, the attribute information is not limited to “service to be provided” and “service to be used” if the attribute information is capable of associating information transmission and reception between the functional units 32.

(5c) The above-described embodiment has illustrated the configuration that issues a service information request or an update routing table request to the server 12 when the determiner 63 determines that the functional unit 32 increases. The above-described request may be issued to the server 12 without the determination by the determiner 63.

(5d) A plurality of functions of one element in the above embodiment may be implemented by a plurality of elements, or one function of one element may be implemented by a plurality of elements. A plurality of functions of a plurality of elements may be implemented by one element, or one function implemented by a plurality of elements may be implemented by one element. A part of the configuration of the above embodiment may be omitted. At least a part of the configuration of the above embodiment may be added to or replaced with another configuration of the above embodiment. All modes included in the technical idea identified by the wording described in the claims correspond to embodiments of the present disclosure.

(5e) The present disclosure can be embodied by not only the above-described information management system 1, but also various forms such as the in-vehicle device 11 or the server 12 as a composing element of the information management system 1, a program allowing a computer to function as the in-vehicle device 11 or the server 12, a non-transitory tangible storage medium such as a semiconductor memory to store the program, and a routing table modification method.

1. An information management system comprising:
an in-vehicle device mounted on a vehicle; and
a server configured to communicate with the in-vehicle device, wherein
the in-vehicle device includes at least one information processor configured to communicate with a plurality of functional units each of which provides a predetermined function,
the at least one information processor further configured to:
relay communication between the plurality of functional units based on a routing table; and
acquire at least one discrete identification information item out of a plurality of discrete identification information items each of which corresponds to one of the plurality of functional units, and
the in-vehicle device further includes a transmitter configured to transmit the at least one discrete identification information item acquired by the at least one information processor to the server,
the server includes a server processor configured to acquire a discrete attribute information item of at least one of the plurality of functional units corresponding to the at least one discrete identification information item transmitted from the transmitter, and
the information management system further comprising:
a finalizer processor configured to determine a change in the routing table based on a plurality of discrete attribute information items each of which corresponds to one of the plurality of functional units, the plurality of discrete attribute information items including the discrete attribute information item of the at least one of the plurality of functional units acquired by the server processor; and
a changer processor configured to execute the change in the routing table based on the change determined by the finalizer processor, wherein the finalizer processor is included in the at least one information processor or the server.

2. The information management system according to claim 1, wherein
each of the plurality of discrete attribute information items includes:
a content indicating information configured to be output in response to an execution of the function by the at least one of the plurality of functional units related to the corresponding one of the plurality of discrete attribute information items; and
a content indicating information configured to be output from another one of the plurality of functional units and to be required for the at least one of the plurality of functional units to execute the function.

3. The information management system according to claim 1, wherein the in-vehicle device includes the finalizer processor and the changer processor.

4. The information management system according to claim 1, wherein
the server includes the finalizer processor, and the in-vehicle device includes the changer processor.

5. The information management system according to claim 1, wherein
the server includes the finalizer processor and the changer processor.

6. The in-vehicle device configuring the information management system according to claim 1.

7. The server configuring the information management system according to claim 1.

8. An in-vehicle device mounted on a vehicle and configured to communicate with a server outside the vehicle, the in-vehicle device comprising:
at least one information processor configured to communicate with a plurality of functional units each of which provides a predetermined function,
the at least one information processor further configured to:
relay communication between the plurality of functional units based on a routing table; and
acquire at least one discrete identification information item out of a plurality of discrete identification information items each of which corresponds to one of the plurality of functional units; and
the in-vehicle device further includes a transmitter configured to transmit the at least one discrete identification information item acquired by the at least one information processor to the server, wherein
the server includes a server processor configured to acquire a discrete attribute information item of at least one of the plurality of functional units corresponding to the at least one discrete identification information item transmitted from the transmitter,
the at least one information processor further configured to determine a change in the routing table based on a plurality of discrete attribute information items each of which corresponds to one of the plurality of functional units, and
the plurality of discrete attribute information items includes the discrete attribute information item of the at least one of the plurality of functional units acquired by the server processor.

9. A server configured to communicate with an in-vehicle device mounted on a vehicle, the in-vehicle device being configured to, based on a routing table, relay communication between a plurality of functional units each of which is attached to the vehicle and provides a predetermined function,
the server comprising a server processor configured to:
acquire a discrete attribute information item of at least one functional unit based on the discrete identification information item that corresponds to the at least one functional unit out of the plurality of functional units;
determine a change in the routing table based on a plurality of discrete attribute information items each of which corresponds to one of the plurality of functional units, the plurality of discrete attribute information items including the discrete attribute information item of the at least one of the plurality of functional units.

10. A routing table change method used when a communication relayer included in a client relays communication between a plurality of functional units each of which provides a predetermined functions, the client configured to communicate with a server and including at least one information processor configured to communicate with the plurality of functional units,
the routing table change method comprising:
acquiring, by the client, a discrete identification information item that corresponds to at least one functional unit out of the plurality of functional units;
acquiring, by the server, a discrete attribute information item of the at least one functional unit based on the discrete identification information item, the at least one functional unit being specified by the discrete identification information item;
determining, by the server or the at least one information processor, a change in a routing table based on a plurality of discrete attribute information items each of which corresponds to one of the plurality of functional units, the plurality of discrete attribute information items including the discrete attribute information item of the at least one functional unit; and
executing the change in the routing table based on the determined change.
